(19) United States
(12) Patent Application Publication
(10) Pub. No.: US 2026/0139791 A1
(43) Pub. Date: May 21, 2026

(54) Universal Bracket for a Hand Truck

(71) Applicant: Magline, Inc., Standish, MI (US)

(72) Inventor: Chad David Winters, Bay City, MI (US)

(21) Appl. No.: 19/360,320

(22) Filed: Oct. 16, 2025

Related U.S. Application Data
(60) Provisional application No. 63/721,625, filed on Nov. 18, 2024.

(51) Int. Cl. F16M 13/02; B62B 1/14; B62B 5/06

(52) U.S. Cl. CPC F16M 13/02; B62B 1/14; B62B 5/06

(57) ABSTRACT

A universal bracket for a hand truck is disclosed, comprising a handle connection portion and a rail connection portion integrated into a one-piece construction. The handle connection portion is designed to connect to a secondary handle to the hand truck, featuring a generally rounded shape to accommodate the secondary handle and a plurality of strategically positioned fasteners to prevent wobbling or loosening during operation. The rail connection portion is configured to connect to the rail of the hand truck, including a protrusion that slides within an indentation on the rail and a plurality of fasteners to ensure secure attachment under heavy loads or rigorous use. The hand connection portion may include a slit opening located between two mating edges of the hand connection portion, wherein the mating edges may be beveled. The universal bracket may have a strap attachment aperture formed therein and configured to receive a strap therein, the strap being used to secure a load to the hand truck.

### CROSS-REFERENCE TO RELATED APPLICATION

This application claims the benefit of the priority date of U.S. Provisional Application Ser. No. 63/721,625, filed on Nov. 18, 2024, the contents of that application being incorporated by reference herein in their entirety and for all purposes.

### FIELD OF INVENTION

The present invention generally relates to a hand truck, more specifically, to a universal attachment bracket for mounting. The present disclosure relates to light material handling equipment. Light material handling equipment encompasses a wide variety of wheeled carts, trollies, and hand trucks (e.g., dollies). These devices are typically manually operated by an operator who pushes or pulls the equipment. There are also motor-assisted (i.e., motorized) devices, which may include some type of device or mechanism to propel the device, truck, or cart without the operator having to exert a significant (or even zero) effort to cause the device to move.

### BACKGROUND

Generally, it is known to provide a wheeled device that typically stands vertically on two wheels and has an upper portion to be held by the operator to load cargo, and to then tilt the loaded cargo and wheel the loaded cargo to a different location. It is also known to provide a hand truck including rear stabilizer wheels, which allow the hand truck to be tilted or leaned back and rested on the primary wheels and the rear stabilizer wheels. There is a wide variety of application-specific hand trucks based upon the above generally known designs. Such known application-specific hand trucks may be known as drum dollies (for moving 55-gallon drums), cylinder trucks (for moving high-pressure gas cylinders), tree dollies (for moving trees with ball roots), and water dollies (for moving multiple 5-gallon tanks of drinking water), to name only a few. It is generally known that any of these examples may be manually-operated or may be motor-assisted devices.

One of the primary issues with conventional hand trucks is the instability and lack of secure attachment between the handle and the rail. Handles are typically connected to the rails using basic fasteners or welding, which may not provide a robust and durable connection. Over time, these connections can become loose, leading to wobbling or detachment of the handle from the rail. This instability not only makes the hand truck difficult to control but also poses a significant safety hazard, as the load may shift or fall unexpectedly during transport.

Another problem associated with traditional hand trucks is the ergonomic design of the handle. Many hand trucks feature handles that are not optimized for user comfort, leading to strain and fatigue during prolonged use. An uncomfortable handle can reduce the efficiency of the user and increase the risk of repetitive strain injuries. Furthermore, the lack of a secure and ergonomic handle can make it challenging to maneuver the hand truck, especially when navigating tight spaces or uneven surfaces.

The attachment mechanism between the handle and the rail also presents challenges. Traditional designs often rely on simple brackets or clamps that may not provide a snug fit or may be difficult to adjust. This can result in a poor connection that does not adequately support the weight of the load, leading to potential damage to the hand truck or the transported items.

Additionally, visibility is a critical concern when using hand trucks, particularly in low-light conditions or at night. Traditional hand trucks often lack features that enhance visibility, increasing the risk of accidents and collisions. Poor visibility can be especially problematic in busy warehouses or outdoor environments where obstacles and other hazards may not be easily seen.

In summary, the conventional design of hand trucks presents several issues, including insecure handle-to-rail connections, poor ergonomic handle design, inadequate attachment mechanisms, and insufficient visibility features. These problems can lead to reduced functionality, increased physical strain on users, and heightened safety risks. There is a need for an improved solution that addresses these challenges to enhance the performance, usability, and safety of hand trucks.

It is also generally known that there is a vast amount of known hand trucks for many different uses. The known hand trucks vary a great deal and may include simple mechanical clamping mechanisms to secure the load to the truck and/or to provide for manual braking devices. It is also further known to provide more complex and motorized hand trucks that can lift and lower loads. There are many adaptations and versions of hand trucks to meet the many varying needs of specific uses or applications, since a hand truck may be used in so many ways and in so many industries.

With the hand trucks of the prior art, as shown in FIG. 1, the handle of the hand truck connects to the rail of the hand truck using a plurality of brackets and different parts. Accordingly, there exists a need in the industry to provide an improved bracket universal to numerous hand truck designs.

### BRIEF DESCRIPTION OF THE DRAWINGS

The operation of the invention may be better understood by reference to the detailed description taken in connection with the following illustrations, wherein:

FIG. 1 illustrates several embodiments of a prior art hand truck in various models;

FIG. 2 illustrates several embodiments of a new novel hand truck in various models;

FIG. 3 illustrates a close-up perspective view of the universal bracket connected to the rails of a hand truck, connecting the handle to the hand truck;

FIG. 4 illustrates a close-up perspective view of the universal bracket connected to the rails of a hand truck, connecting the handle to the hand truck;

FIG. 5 illustrates a close-up perspective view of the universal bracket connected to the rails of a hand truck, connecting the handle to the hand truck;

FIG. 6 illustrates a close-up perspective view of the universal bracket connected having a reflector to the rails of a hand truck, connecting the handle to the hand truck;

FIG. 7 illustrates a close-up perspective view of the universal bracket connected to the rails of a hand truck connecting the handle to the hand truck;

FIG. 8 illustrates an alternative embodiment of the universal bracket including an aperture for the hand truck;

FIG. 9 illustrates an alternative embodiment of the universal bracket including an aperture for the hand truck; and

FIG. 10 illustrates an alternative embodiment of the universal bracket connected to the rails of the hand truck, connecting the handle to the hand truck, and including a strap attachment.

### DETAILED DESCRIPTION

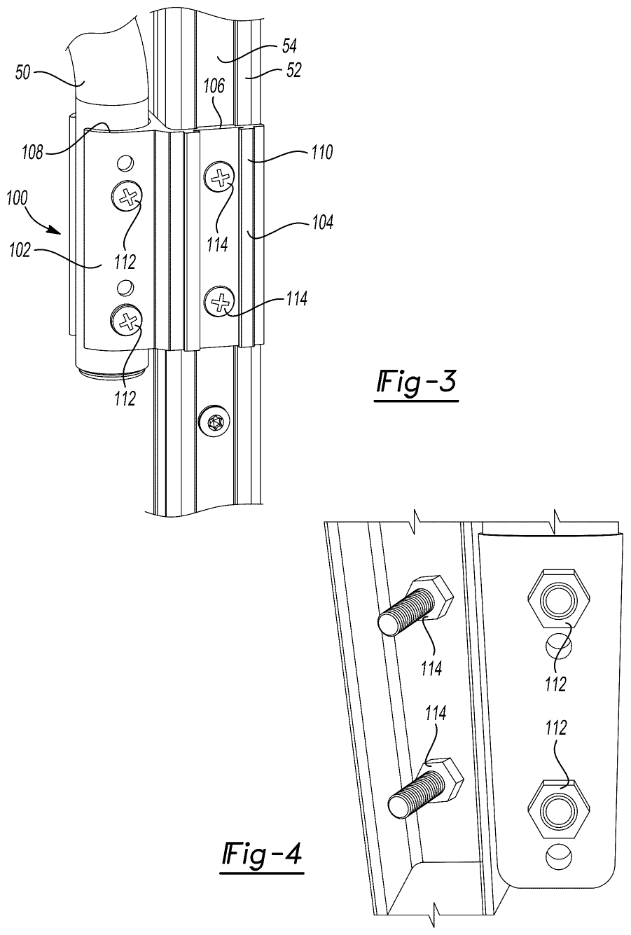

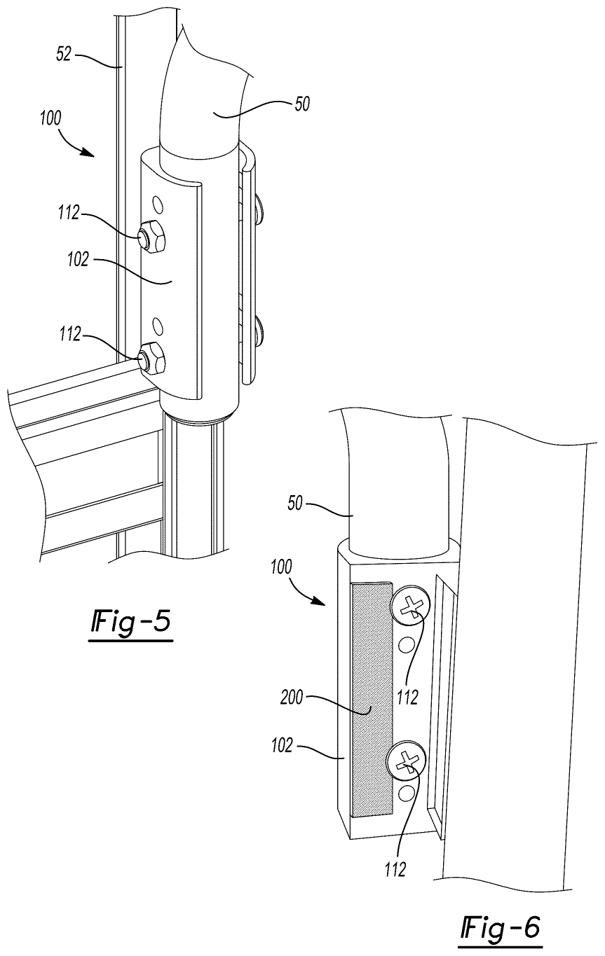

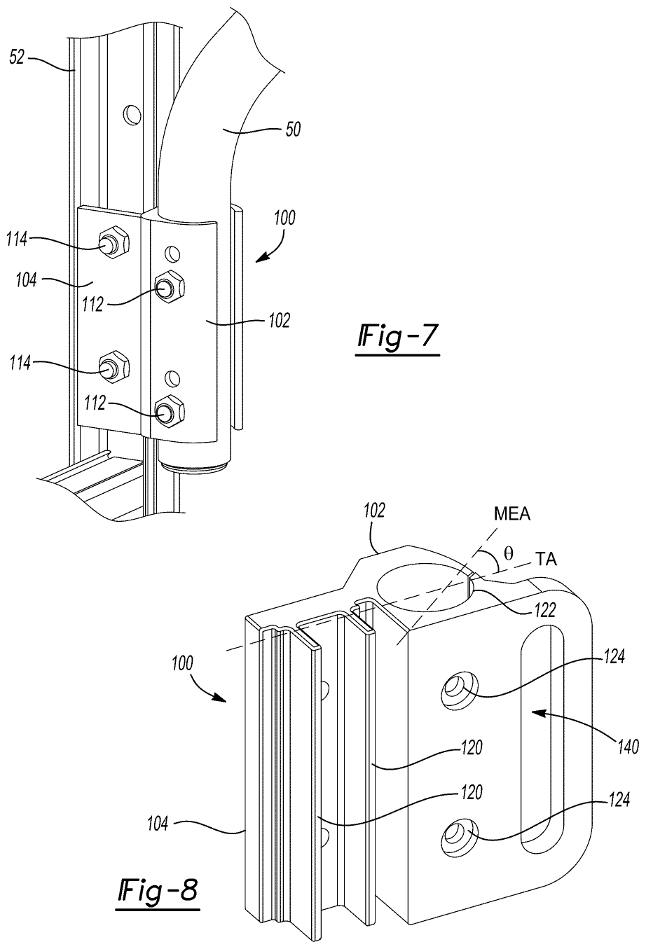

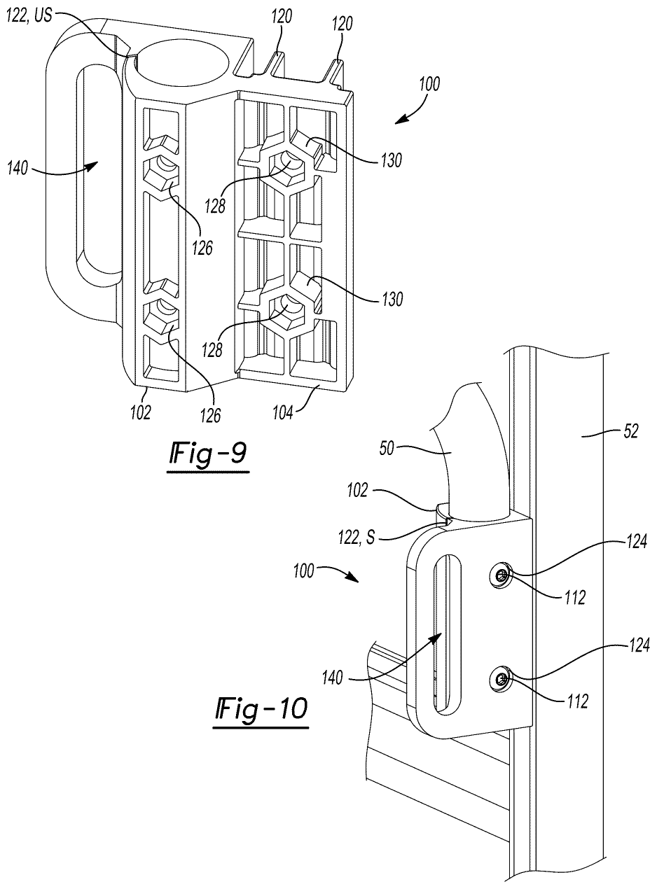

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. For example, the universal bracket embodiment depicted in FIGS. 3-7 may include the strap attachment aperture of FIGS. 8-10, or alternatively, the universal bracket embodiment depicted in FIGS. 8-10 may be free of the strap attachment aperture, as is shown in FIGS. 3-7. As such, the following description is presented by way of illustration only and should not limit in any way the various alternatives and modifications that may be made to the illustrated embodiments and still be within the spirit and scope of the invention.

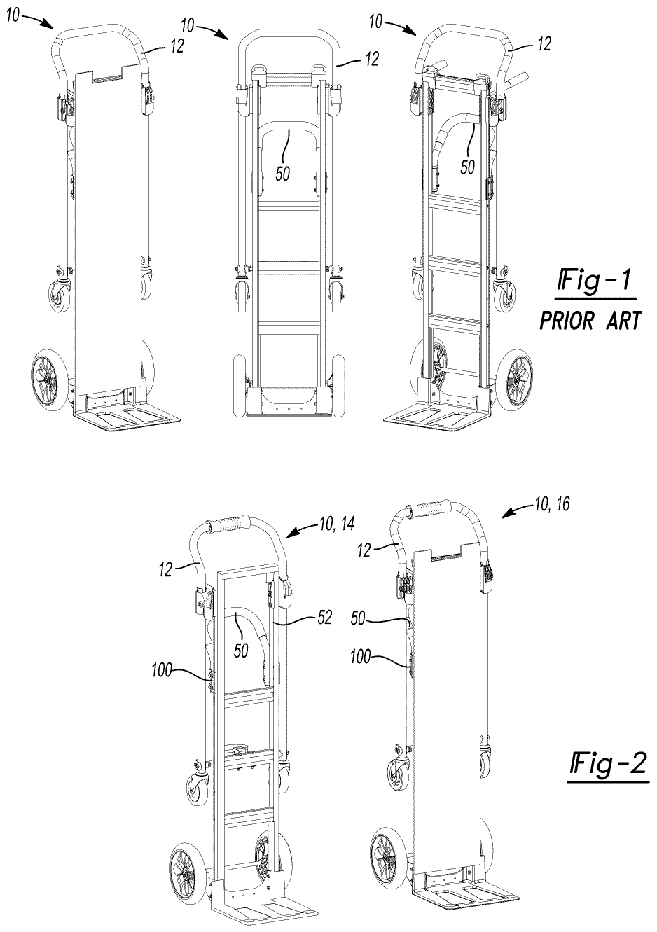

FIG. 1 illustrates several embodiments of hand trucks 10 known in the art. The hand trucks include a primary handle 12 and a secondary handle 50, the secondary handle 50 being attached to the hand truck 10 by traditional means such as conventional brackets or the like.

FIGS. 2-7 illustrate a universal bracket 100, shown in some figures installed on the hand truck 10. FIG. 2 depicts different models 14 and 16 of hand trucks 10, all of which include a primary handle 12 separate from a secondary handle 50. The universal bracket 100 is used to affix the secondary handle 50 to a rail 52 of the hand truck 10.

FIG. 2 provides a close-up view of the universal bracket 100 affixed to the hand truck. The universal bracket 100 includes a handle connection portion 102 and a rail connection portion 104. The handle connection portion 102 connects the handle 50 to a rail 52 by means of the rail connection portion 104.

The handle connection portion 102 is generally rounded to accommodate the handle 50. The handle connection portion 102 includes an upper end 108 and a plurality of fasteners 112 to secure the handle connection portion 102 to the handle 50. These fasteners 112 are strategically positioned to ensure a firm and secure attachment, preventing any wobbling or loosening during the operation of the hand truck. The rounded design of the handle connection portion 102 not only provides a snug fit for the handle 50 but also enhances the ergonomic grip for the user, making it easier to maneuver the hand truck. The open design of the handle connection portion 102 allows for easy, sliding installation and replacement of the universal bracket 100. Alternatively, the handle connection portion 102 can be formed such that there is not an opening along the longitudinal length of that portion.

The rail connecting portion 104 is configured to connect to an indentation 54 on the rail 52 of the hand cart. The protrusion 106 of the rail connection portion 104 connects directly and slides within the indentation 54 of the rail 52. A plurality of fasteners 114 may be used to secure the universal bracket 100, specifically the rail connection portion 114, to the rail 52 of the hand truck 10. These fasteners 114 ensure that the bracket remains securely attached to the rail, even under heavy loads or during rigorous use. The rail connection portion may further include an elongated rib 110 that can be utilized to mount additional features.

FIGS. 8-10 illustrate an alternative embodiment of a universal bracket 100, shown in some figures installed on a hand truck 10. The universal bracket 100 includes a handle connection portion 102 and a rail connection portion 104. The handle connection portion 102 connects the handle 50 to a rail 52 by means of the rail connection portion 104. The embodiment in FIGS. 8-10 depicts the handle connection portion 102 having a slit design.

The handle connection portion 102 is generally rounded to accommodate the handle 50. The handle connection portion 102 includes bolt head recessions 124 in order to receive a plurality of fasteners 112, which secure the handle connection portion 102 to the handle 50. These fasteners 112 are strategically positioned to ensure a firm and secure attachment, preventing any wobbling or loosening during the operation of the hand truck. The rounded design of the handle connection portion 102 not only provides a snug fit for the handle 50 but also enhances the ergonomic grip for the user, making it easier to maneuver the hand truck.

The handle connection portion 102 is not fully enclosed and includes mating edges 122. The slit opening between the mating edges 122 allows for the handle connection portion 102 to have some flexural give, making the sliding of the universal bracket 100 during installation and removal easier. During installation and removal, the handle connection portion is in an unsecured US arrangement. Once fasteners 112 are secured through the bolt head recessions 124, the handle connection portion 102 is in a secured arrangement S. In a secured arrangement S, the fasteners 112 are tightened such that the mating edges 122 abut each other, closing the slit opening between them.

The mating edges 120 may be beveled. The angle of the bevel may be defined a the mating edge angle θ. The mating edge angle θ may be formed between a transverse axis TA of the universal bracket 100 and a mating edge axis MEA. The beveled edge may be chamfered, rounded, L-shaped, J-shaped, or any other suitable shape. The beveled edge may include a combination of shapes. The beveled edge of the mating edges 122 provides for a more aesthetic design. When the handle connection portion 102 is tightened into a secured arrangement S, the beveled edges ensure that the secondary handle 50 is no longer visible in the slit opening between the mating edges 122. Alternatively, the edges of the mating edges 120 may be generally planar and not angled.

In some embodiments, the handle connection portion 122 of the universal bracket 100 further includes a strap attachment aperture 140 configured to receive a strap. The strap attachment aperture 140 allows for a strap to be affixed to either side of the hand truck 10 in order to secure the load being transported thereon. While the strap attachment aperture 140 is depicted as extending from the handle connection portion 102, the strap attachment aperture 140 may be integrated into any portion of the universal bracket 100. Furthermore, while the strap attachment aperture 140 is depicted as being oval in shape, any shape that accommodates the desired attachment strap may be realized.

The rail connecting portion 104 includes rail mating projections 120 configured to connect to a reciprocal indentation (not shown) on the rail 52 of the hand cart 10. The rail mating projections 120 of the rail connection portion 104 connect directly to and slide within the indentation (not shown) of the rail 52. A plurality of fasteners 114 may be used to secure the universal bracket 100, specifically the rail connection portion 114, to the rail 52 of the hand truck 10. These fasteners 114 ensure that the universal bracket 100 remains securely attached to the rail, even under heavy loads or during rigorous use.

The handle connection portion, the rail connection portion, or both may include nut recesses 126 and 128. The nut recesses 126 in the handle connection portion 102 and/or the nut recesses 128 in the rail connection portion 104 may be framed by ribs 130 extending around at least a portion of the nut recesses 126 and 128. The ribs 130 may be sufficiently thick to prevent the fasteners 112 and 114 from breaking the surrounding materials, including the handle connection portion 102 and/or the rail connection portion 104 of the universal bracket. Additionally, the nut recesses 126, 128 are adapted to prevent the nut from spinning, as such enabling one tool assembly.

In some embodiments, a reflector 200 may be provided on an outer surface of the universal bracket 100, as is shown in FIG. 6. This reflector 200 enhances the visibility of the hand truck, especially in low-light conditions or during nighttime use. The reflector 200 can be made from various materials, including reflective tape or plastic, and can be attached using adhesive or fasteners. By incorporating a reflector 200, the universal bracket 100 not only improves the functionality of the hand truck but also contributes to the safety of the user, reducing the risk of accidents in poorly lit environments.

In all embodiments, the universal bracket 100 may be fabricated from plastic, polymers, or the like. As used herein, plastic, polymer, and the like are used to broadly encompass all natural, synthetic, and semi-synthetic polymeric substances, including homopolymers, copolymers, blends, composites, laminates, derivatives, and equivalents thereof. Such materials may include, without limitation, thermoplastics, thermosets, elastomers, bio-based and biodegradable polymers, functional polymers, and any polymeric materials hereafter developed. Unless expressly stated otherwise, these terms are intended to be construed in their broadest sense to cover all polymeric materials suitable for the described application. Preferably, the universal bracket may be made from nylon, glass-filled nylon, carbon reinforced plastics, polypropylene, thermoplastic polyurethane, as well as specially compounded thermoplastics such as EMS Grivory GVL-6H HP and GVX65H.

The universal bracket 100 may be assembled as a one-piece construction, as is shown in FIGS. 3-10. The universal bracket 100 may be molded, extruded, 3D printed, or otherwise created. The universal bracket may be integrally formed.

Alternatively, a two-piece construction may be realized. The two-piece design of the universal bracket 100 may be in the form of a clamshell that can be placed on either side of the hand truck 10 and secondary handle 50 before being fastened together. The clamshell portions may be identical, allowing for interchangeability of the halves of the clamshell, reducing production complexity. Furthermore, if only a portion of the universal bracket 100 needs to be replaced, only one half of the clamshell design has to be removed, replaced, and reinstalled, reducing material costs and repair time. Additionally or alternatively, the two-piece design may include two slits openings in the handle connection portion 102, as opposed to the singular slit opening formed between the two mating edges 122 depicted in FIGS. 8-10.

The open design of the handle connection portion 102, as depicted in FIGS. 3-7, as well as the slit design of the hand connection portion 102, as depicted in FIGS. 8-10, provides for an improvement in the installation, removal, and replacement process of the universal bracket 100. The open design and the slit design allow for the universal bracket 100 to easily slide over the secondary handle 50 during installation and removal without compromising the secure fit of the universal bracket 100 once the fasteners are utilized.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended, and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of the same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components, or steps identified, and such other elements, ingredients, components, or steps that do not materially affect the basic and novel characteristics of the combination. The use of the terms “comprising” or “including” to describe combinations of elements, ingredients, components, or steps herein also contemplates embodiments that consist essentially of, or even consist of, the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps. All references herein to elements or metals belonging to a certain group refer to the Periodic Table of the Elements published and copyrighted by CRC Press, Inc., 1989. Any reference to the group or groups shall be to the group or groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

What is claimed is:

1. A universal bracket for a hand truck, comprising:
a handle connection portion configured to connect to a secondary handle to the hand truck, the handle connection portion being generally rounded to accommodate the secondary handle and including an upper end and a plurality of fasteners strategically positioned to secure the handle connection portion to the secondary handle, thereby preventing wobbling or loosening during operation of the hand truck;
a rail connection portion configured to connect to a rail of the hand truck, the rail connection portion comprising a protrusion that connects directly and slides within an indentation on the rail, and a plurality of fasteners to secure the rail connection portion to the rail, ensuring the bracket remains securely attached under heavy loads or rigorous use; and
wherein the handle connection portion and the rail connection portion are assembled as a one-piece construction, which may be molded, extruded, 3D printed, or otherwise created to reduce material weight of the universal bracket.

2. The universal bracket for a hand truck of claim 1, wherein the universal bracket further comprises a reflector on an outer surface of the universal bracket, the reflector being made from reflective materials and attached using adhesive or fasteners, to enhance the visibility of the hand truck in low-light conditions or during nighttime use, thereby improving safety for the user.

3. The universal bracket for a hand truck of claim 1, wherein the universal bracket is comprised of nylon or glass-filled nylon.

4. The universal bracket for a hand truck of claim 1, wherein the universal bracket is comprised of carbon reinforced plastics, carbon reinforced polypropylene, or carbon reinforced thermoplastic polyurethane.

5. A universal bracket for a hand truck, comprising:
a handle connection portion configured to connect to a secondary handle to the hand truck, the handle connection portion being generally rounded to accommodate the secondary handle and including an upper end and a plurality of fasteners strategically positioned to secure the handle connection portion to the secondary handle, thereby preventing wobbling or loosening during operation of the hand truck; and
a rail connection portion configured to connect to a rail of the hand truck, the rail connection portion comprising a protrusion that connects directly and slides within an indentation on the rail, and a plurality of fasteners to secure the rail connection portion to the rail, ensuring the bracket remains securely attached under heavy loads or rigorous use;
wherein the hand connection portion includes a slit opening located between two mating edges of the hand connection portion.

6. The universal bracket for a hand truck of claim 5, wherein the mating edges are beveled; and
wherein the bevel is at a mating edge angle formed between a mating edge axis and a transversal axis of the universal bracket.

7. The universal bracket for a hand truck of claim 6, wherein the mating edge bevel is oblique to the transversal axis of the universal bracket.

8. The universal bracket for a hand truck of claim 5, wherein the handle connection portion, the rail connection portion, or both include one or more nut recesses formed therein.

9. The universal bracket for a hand truck of claim 8, wherein the one or more nut recesses are framed by ribs, the ribs extending around at least a portion of the one or more nut recesses;
wherein the ribs are sufficiently thick to prevent the plurality of fasteners placed therein from breaking surrounding materials; and
wherein the nut recesses are adapted to prevent the nut from spinning, as such enabling one tool assembly.

10. The universal bracket for a hand truck of claim 5, wherein the universal bracket is comprised of nylon or glass-filled nylon.

11. The universal bracket for a hand truck of claim 5, wherein the universal bracket is comprised of carbon reinforced plastics, carbon reinforced polypropylene, or carbon reinforced thermoplastic polyurethane.

12. The universal bracket for a hand truck of claim 1, wherein the universal bracket is adapted such that the universal bracket can be utilized on both a left-hand side and a right-hand side of the hand truck.

13. A universal bracket for a hand truck, comprising:
a handle connection portion configured to connect to a secondary handle to the hand truck, the handle connection portion being generally rounded to accommodate the secondary handle and including an upper end and a plurality of fasteners strategically positioned to secure the handle connection portion to the secondary handle, thereby preventing wobbling or loosening during operation of the hand truck;
a rail connection portion configured to connect to a rail of the hand truck, the rail connection portion comprising a protrusion that connects directly and slides within an indentation on the rail, and a plurality of fasteners to secure the rail connection portion to the rail, ensuring the bracket remains securely attached under heavy loads or rigorous use; and
a strap attachment aperture configured to receive a strap therein, the strap being used to secure a load to the hand truck.

14. The universal bracket for a hand truck of claim 13, wherein the strap attachment aperture is formed within the handle connection portion.

15. The universal bracket for a hand truck of claim 13, wherein the strap attachment aperture is oval in shape.

16. The universal bracket for a hand truck of claim 13, wherein the handle connection portion, the rail connection portion, or both include one or more nut recesses formed therein.

17. The universal bracket for a hand truck of claim 13, wherein the one or more nut recesses are framed by ribs, the ribs extending around at least a portion of the one or more nut recesses;
wherein the ribs are sufficiently thick to prevent the plurality of fasteners placed therein from breaking surrounding materials; and
wherein the nut recesses are adapted to prevent the nut from spinning, as such enabling one tool assembly.

18. The universal bracket for a hand truck of claim 13, wherein the universal bracket is comprised of nylon or glass-filled nylon.

19. The universal bracket for a hand truck of claim 13, wherein the universal bracket is comprised of carbon reinforced plastics, carbon reinforced polypropylene, or carbon reinforced thermoplastic polyurethane.

20. The universal bracket for a hand truck of claim 13, wherein the universal bracket is adapted such that the universal bracket can be utilized on both a left-hand side and a right-hand side of the hand truck.
